(19) United States
(12) Patent Application Publication
(10) Pub. No.: US 2006/0085794 A1
(43) Pub. Date: Apr. 20, 2006

(54) Information processing system, information processing method, and program

(76) Inventor: Tomonori Yokoyama, Tokyo (JP)

Correspondence Address: BELL, BOYD & LLOYD, LLC, P. O. BOX 1135, CHICAGO, IL, 60690-1135, US

(21) Appl. No.: 11/231,008

(22) Filed: Sep. 19, 2005

(30) Foreign Application Priority Data
Oct. 14, 2004 (JP) P2004-299538

(51) Int. Cl. G06F 9/46

(52) U.S. Cl. 718/100

(57) ABSTRACT

An information processing system, information processing method, and program are provided. The information processing system including a plurality of computing units includes an operating system execution unit executing an operating system and a management application execution unit executing a management application that manages an operation of the operating system. The operating system execution unit and the management application execution unit correspond to any of the plurality of computing units. The operating system execution unit can execute a plurality of operating systems. At least one of the plurality of operating systems has a function of transmitting a state change request to the management application. When the management application receives a state change request from a first operating system in a state where the plurality of operating systems are executed by the operating system execution unit, the management application controls an operation state of a set of physical resources used by the first operating system.

### CROSS REFERENCE TO RELATED APPLICATIONS

The present application claims priority to Japanese Patent Application No. 2004-299538 filed in the Japan Patent Office on Oct. 14, 2004, the entire contents of which being incorporated herein by reference.

### BACKGROUND

The present invention relates to an information processing system, an information processing method, and a program. Particularly, the present invention relates to an information processing system, an information processing method, and a program used in a computer system having a logical partitioning function.

For example, in a case where only one operating system (OS) is executed at one time as in a typical personal computer, the personal computer or the OS often has a suspend function of storing an executed operation state of the OS in a memory and then stopping the operation to change to a power saving mode after it is detected that a user has not input any operation for a predetermined time period and releasing the power saving mode to recover the previous state at restart, or a hibernation function of storing an execution state of the OS in a storage device such as a hard disk and stopping power supply to the apparatus after it is detected that a user has not operated the computer for a predetermined time period. When the suspend function is executed, power supply to the apparatus is not stopped in order to hold the content of the memory. When the hibernation function is executed, power supply to the apparatus is stopped, and when the operation is restarted, data recorded in the storage device is reloaded to the memory, so that the state before the hibernation is started, that is, the state of an executed application and a displayed window is recovered. These functions are very effective to reduce unnecessary power consumption.

In recent years, virtual computer systems operated on an x86 processor, such as VMware (trade mark) and VirtualPC (trade mark), have been commonly used.

In general-purpose computers, a virtual computer system having a logical partitioning (LPAR) function has become commercially practical since the 1970s. By using the LPAR function, a physical computer can be divided into a plurality of logical partitions (LPAR partitions) and different operating systems can be executed in the respective logical partitions at the same time. In some cases, physically different devices are assigned to the respective logical partitions. In other cases, one device is shared by a plurality of logical partitions. In some virtual computer systems having the LPAR function, one physical processor can be shared by up to four logical partitions. This state is equivalent to a state where an independent set of resources is assigned to each logical partition, so that each logical partition is not affected by another logical partition (e.g., see, Internet Seminar “The 5th iSeries LPAR”, [online], IBM Japan, Ltd. [searched on Sep. 1, 2004] on the Internet, <http://www-6.ibm.com/jp/servers/eserver/iseries/seminar/lpar/lpar5.html>

However, since the virtual computer systems having the LPAR function have been used only in large general-purpose computers, reduction of power consumption has not been considered. Therefore, in a multiple OS environment where a plurality of operating systems are executed in a physical computer, a suspend or resume function is not executed even when one of the operating systems is in an idling state.

When the virtual computer system having the LPAR function is to be used in a computer system that can be used by a general user, e.g., a compact information processor commonly used by a general user, such as a personal computer, or a small-scale computer system constituted by a home network, reduction of power consumption should be considered.

In the virtual computer system, even when one of operating systems is not used, other operating systems may continue an operation, and thus the same power consumption reducing method as that used in a non-virtual computer system (a computer system in which only one OS can be executed) is not applied. For example, when a user does not operate a first OS for a long time and when a second OS executing a network service has to continue to provide the service, it may be impossible to stop the operation at a part related to the network service and power supply to the part, and thus the operation of the system is continued. Therefore, it may be impossible to reduce the power consumption by shutting off power supply in the same way as in the known case even when one of the OSs is in an idling state. Accordingly, unnecessary power is disadvantageously consumed even if the user does not operate the first OS for a long time.

In a virtual computer system operated on an x86 processor that is becoming common in recent years, such as VMware (trade mark) and VirtualPC (trade mark), the suspend function or the hibernation function is provided. However, these functions are used to stop the entire system or to stop power supply to the entire system, and are not capable of selectively reducing power by stopping only a part that is not used by the user.

### SUMMARY

The present invention has been made in view of these circumstances and is directed to reduce power consumption in a computer system having a logical partitioning function.

An information processing system including a plurality of computing units according to an embodiment of the present invention includes an operating system execution unit for executing an operating system; and a management application execution unit for executing a management application that manages an operation of the operating system. The operating system execution unit and the management application execution unit correspond to any of the plurality of computing units. The operating system execution unit can execute a plurality of operating systems. At least one of the plurality of operating systems that are executed by the operating system execution unit has a function of transmitting a state change request to the management application. When the management application executed by the management application execution unit receives a state change request from a first operating system in a state where the plurality of operating systems are executed by the operating system execution unit, the management application controls an operation state of a set of physical resources used by the first operating system.

The management application executed by the management application execution unit may have a logical partitioning function of logically partitioning the physical resources and allowing respective sets of the physical resources to execute different processes. The plurality of operating systems executed by the operating system execution unit may be respectively executed in a plurality of logical partitions generated by the logical partitioning function of the management application.

At least part of the operating system execution unit and at least part of the management application execution unit may correspond to the same set of the physical resources.

The management application executed by the management application execution unit may have a function of controlling power supply to the set of physical resources used by the first operating system when receiving a state change request from the first operating system.

The information processing system may further include a recording unit for recording predetermined information and being exclusively used by the management application executed by the management application execution unit. The management application executed by the management application execution unit may have a function of allowing the recording unit to record information about an execution state or an executed process of the set of physical resources used by the first operating system and then controlling power supply to the set of physical resources when receiving a state change request from the first operating system.

The information processing system may further include a recording unit for recording predetermined information and not being exclusively used by the first operating system as a set of the physical resources. The management application executed by the management application execution unit may have a function of allowing the recording unit to record information about an execution state or an executed process of the set of physical resources and then controlling power supply to the set of physical resources used by the first operating system when receiving a state change request from the first operating system.

The management application executed by the management application execution unit may have a function of controlling a clock frequency supplied to the set of physical resources used by the first operating system.

When the management application executed by the management application execution unit receives a state change request from the first operating system in a state where the plurality of operating systems are executed by the operating system execution unit, the management application may control an operation state of a set of the physical resources that is used by the first operating system and that is not used by the operating systems other than the first operating system that transmitted the state change request.

The management application executed by the management application execution unit may have a list generating function of generating a list of sets of the physical resources occupied by any of the operating systems in a state where the plurality of operating systems are executed by the operating system execution unit. When the management application receives a state change request from the first operating system in a state where the plurality of operating systems are executed by the operating system execution unit, the management application may refer to the list generated by the list generating function and control an operation state of the set of physical resources that is used by the first operating system and that is not used by the operating systems other than the first operating system that transmitted the state change request.

When the management application executed by the management application execution unit receives a state change request from the first operating system in a state where the plurality of operating systems are executed by the operating system execution unit, the management application may control an operation state of the set of physical resources only during a period assigned to be used by the first operating system in time division.

The management application executed by the management application execution unit may have a logical partitioning function of logically partitioning the physical resources and allowing respective sets of the physical resources to execute different processes. The management application may have a list generating function of generating a list of the sets of the physical resources used in respective logical partitions that are generated by the logical partitioning function in a state where the plurality of operating systems are executed by the operating system execution unit in the respective logical partitions. When the management application receives a state change request from the first operating system in a state where the plurality of operating systems are executed by the operating system execution unit, the management application may refer to the list generated by the list generating function and control an operation state of the set of physical resources only during a period assigned to be used by the first operating system in time division.

At least one of the plurality of operating systems executed by the operating system execution unit may have a function of transmitting a request for changing an operation state of another of the operating systems to the management application executed by the management application execution unit. When the management application executed by the management application execution unit receives a request for changing an operation state of the first operating system from a second operating system while controlling an operation state of the first operating system, the management application may control the operation state of the first operating system based on the request.

In the information processing system according to an embodiment of the present invention, an operating system is executed and an operation thereof is managed. The operating system and its management are executed in any of a plurality of computing units. Further, a plurality of operating systems can be executed, and at least one of the plurality of executed operating systems has a function of transmitting a state change request. When a state change request is transmitted from a first operating system in a state where the plurality of operating systems are executed, an operation state of a set of physical resources used by the first operating system is controlled.

An information processing method according to an embodiment of the present invention includes the steps of: transmitting a state change request from a first operating system executed by any of a plurality of computing units to a management application that manages an operation of the operating system; extracting a set of physical resources whose state can be controlled without causing an effect on a process of a second operating system that is executed in parallel with the first operating system based on the state change request transmitted in the transmitting step; and controlling a state of the set of physical resources extracted in the extracting step.

A program according to an embodiment of the present invention allows a computer to execute a process including the steps of: transmitting a state change request from a first operating system executed by any of a plurality of computing units to a management application that manages an operation of the operating system; extracting a set of physical resources whose state can be controlled without causing an effect on a process of a second operating system that is executed in parallel with the first operating system based on the state change request transmitted in the transmitting step; and controlling a state of the set of physical resources extracted in the extracting step.

In the information processing method and the program according to an embodiment of the present invention, a state change request is transmitted from the first operating system executed in any of a plurality of computing units to a management application that manages an operation of the operating system. Based on the state change request, a set of physical resources whose state can be controlled without causing an effect on a process of a second operating system that is executed in parallel with the first operating system is extracted. Then, the state of the extracted set of physical resources is controlled.

According to an embodiment of the present invention, a plurality of operating systems can be executed. In particular, when a state change request is transmitted from a first operating system in a state where the plurality of operating systems are executed and the operation thereof is managed, an operation state of a set of physical resources used by the first operating system is controlled. Accordingly, a state of a specific set of physical resources can be controlled without causing an effect on operating systems that are being operated in a state where a plurality of operating systems are executed, and thus power consumption can be efficiently reduced.

According to another embodiment of the present invention, a plurality of operating systems can be executed. In particular, when a state change request is transmitted from a first operating system executed in any of computing units to a management application that manages an operation of the operating systems, a set of physical resources whose state can be controlled without causing an effect on a process in a second operating system that is executed in parallel with the first operating system is extracted, and the state of the extracted set of physical resources is controlled. Accordingly, power consumption can be efficiently reduced.

Additional features and advantages are described herein, and will be apparent from, the following Detailed Description and the figures.

### BRIEF DESCRIPTION OF THE FIGURES

FIG. 1 is a block diagram showing a configuration of a computer system according to an embodiment of the present invention.

FIG. 2 illustrates an example of a management OS and guest OSs.

FIG. 3 illustrates assignment of physical memory spaces.

FIG. 4 illustrates another example of the management OS and the guest OSs.

FIG. 5 is a functional block diagram illustrating a function that is executed after the management OS has performed logical partitioning and the guest OSs have been started.

FIG. 6 illustrates a logical partition table.

FIG. 7 illustrates a physical memory space and a logical memory space.

FIG. 8 illustrates a module information table.

FIG. 9 illustrates a memory configuration table.

FIG. 10 illustrates a candidate-for-stop list.

FIG. 11 is a flowchart illustrating a candidate-for-stop list generating process 1.

FIG. 12 is a flowchart illustrating a process performed when a guest OS is executed in a logical partition LPAR/0 and an operation state change request to reduce a clock frequency is transmitted.

FIG. 13 is a flowchart illustrating a process performed when another guest OS executes Hypervisor calling to request restart of an execution of a pausing guest OS to the management OS.

FIG. 14 is a flowchart illustrating an operation state control process.

FIG. 15 is a flowchart illustrating an operation state change process 1.

FIG. 16 is a flowchart illustrating an operation state change process 2.

### DETAILED DESCRIPTION

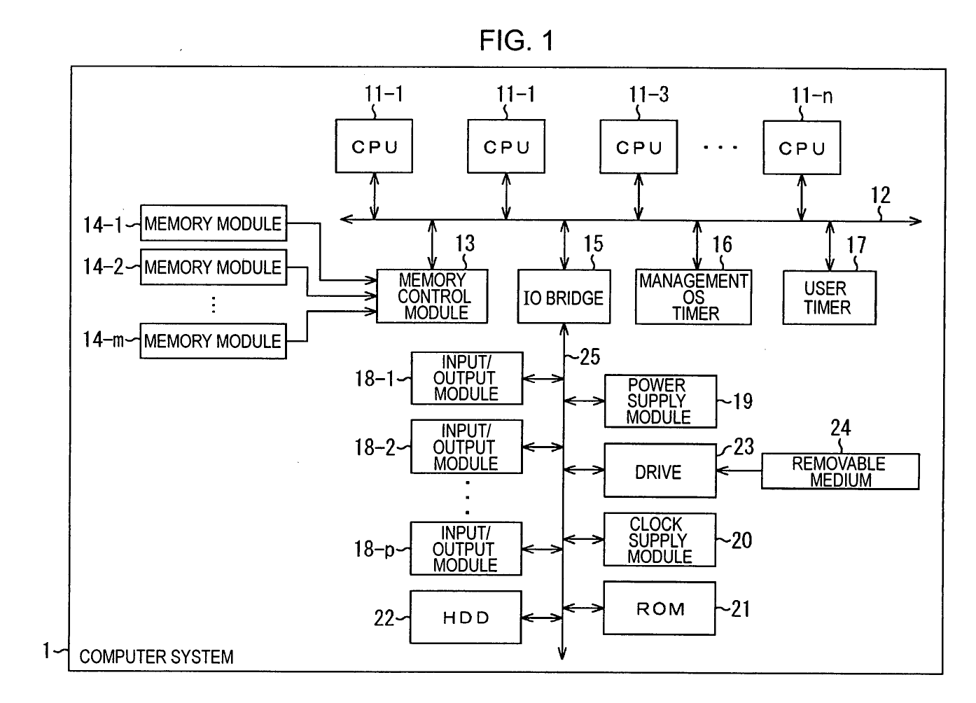

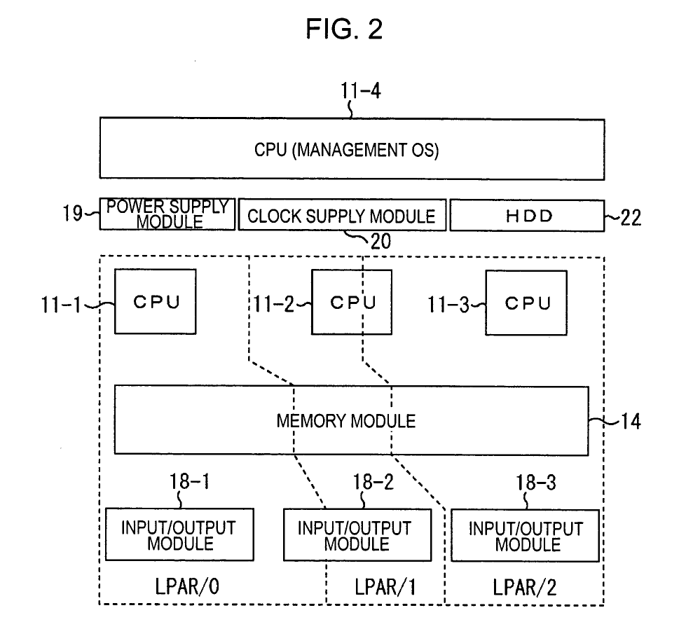

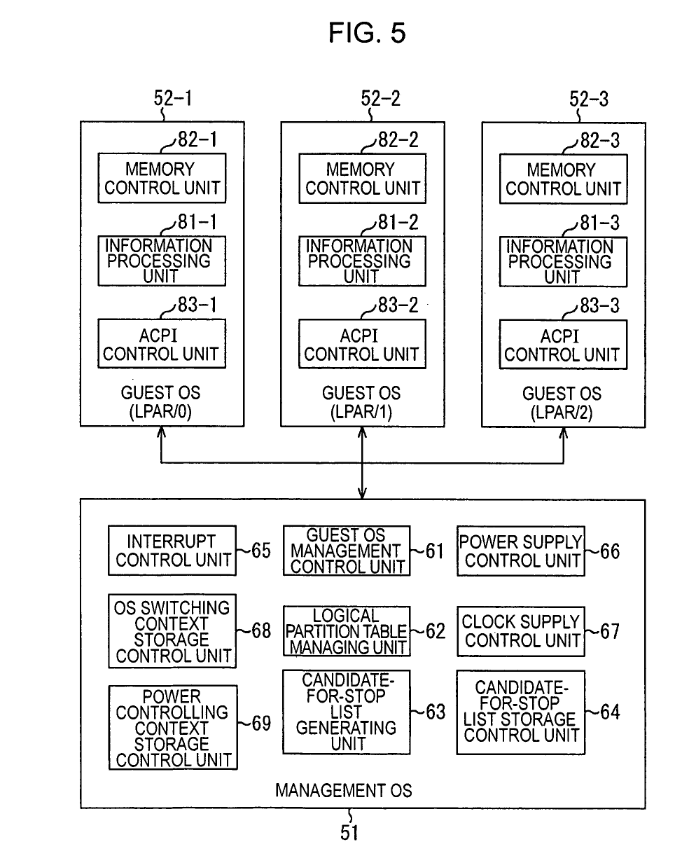

An information processing system according to an embodiment of the present invention is an information processing system (e.g., the computer system 1 in FIG. 1) including a plurality of computing units (e.g., the CPUs 11 in FIG. 1) and includes an operating system execution unit (e.g., the CPUs 11-1 to 11-3 in FIG. 1) for executing an operating system (e.g., the guest OSs 52 in FIG. 5); and a management application execution unit (e.g., the CPU 11-4 in FIG. 2) for executing a management application (e.g., the management OS 51 in FIG. 5) that manages an operation of the operating system. The operating system execution unit and the management application execution unit correspond to any of the plurality of computing units. The operating system execution unit can execute a plurality of operating systems. At least one of the plurality of operating systems that are executed by the operating system execution unit has a function (e.g., a function executed by the ACPI control unit 83 in FIG. 5) of transmitting a state change request (e.g., a state change request to change an operation state) to the management application. When the management application executed by the management application execution unit receives a state change request from a first operating system in a state where the plurality of operating systems are executed by the operating system execution unit, the management application controls an operation state of a set of physical resources (e.g., resources such as the CPU 11, the memory module 14, and the input/output module 18 in FIG. 1) used by the first operating system.

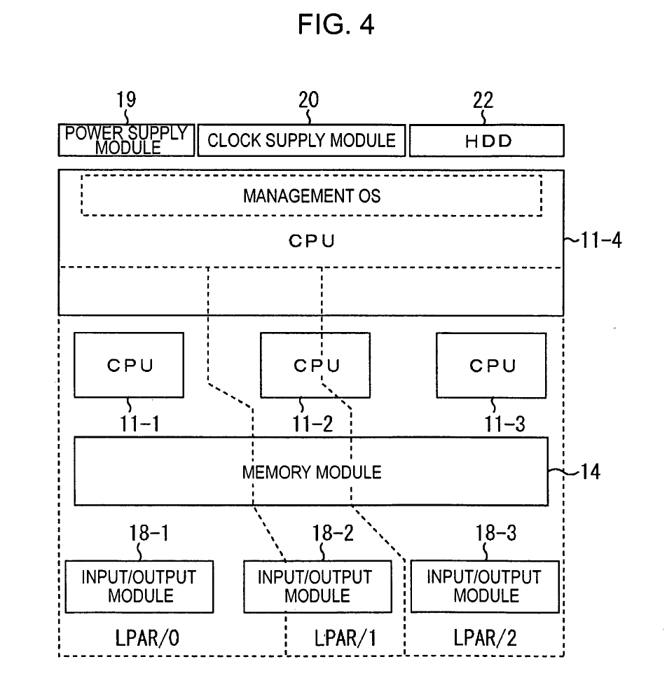

At least part of the operating system execution unit and at least part of the management application execution unit may correspond to the same set of the physical resources (e.g., the CPU 11-4 in FIG. 4).

The management application executed by the management application execution unit may have a function (e.g., a function executed by the power supply control unit 66 in FIG. 5) of controlling power supply to the set of physical resources used by the first operating system when receiving a state change request from the first operating system.

The information processing system may further include a recording unit (e.g., an area of the memory module 14 in FIG. 1 assigned to the management OS 51) for recording predetermined information and being exclusively used by the management application executed by the management application execution unit. The management application executed by the management application execution unit may have a function of allowing the recording unit to record information about an execution state or an executed process of the set of physical resources used by the first operating system and then controlling power supply to the set of physical resources when receiving a state change request from the first operating system.

The information processing system may further include a recording unit (e.g., including an area of the memory module 14 in FIG. 1 assigned to the guest OSs 52 other than the guest OS 52 whose state is changed) for recording predetermined information and not being exclusively used by the first operating system as a set of the physical resources. The management application executed by the management application execution unit may have a function of allowing the recording unit to record information about an execution state or an executed process of the set of physical resources and then controlling power supply to the set of physical resources used by the first operating system when receiving a state change request from the first operating system.

The management application executed by the management application execution unit may have a function (e.g., a function executed by the clock supply control unit 67 in FIG. 5) of controlling a clock frequency supplied to the set of physical resources used by the first operating system.

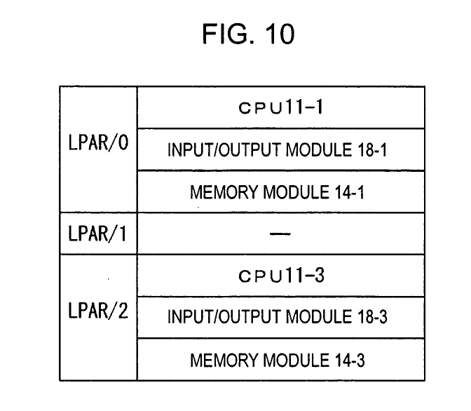

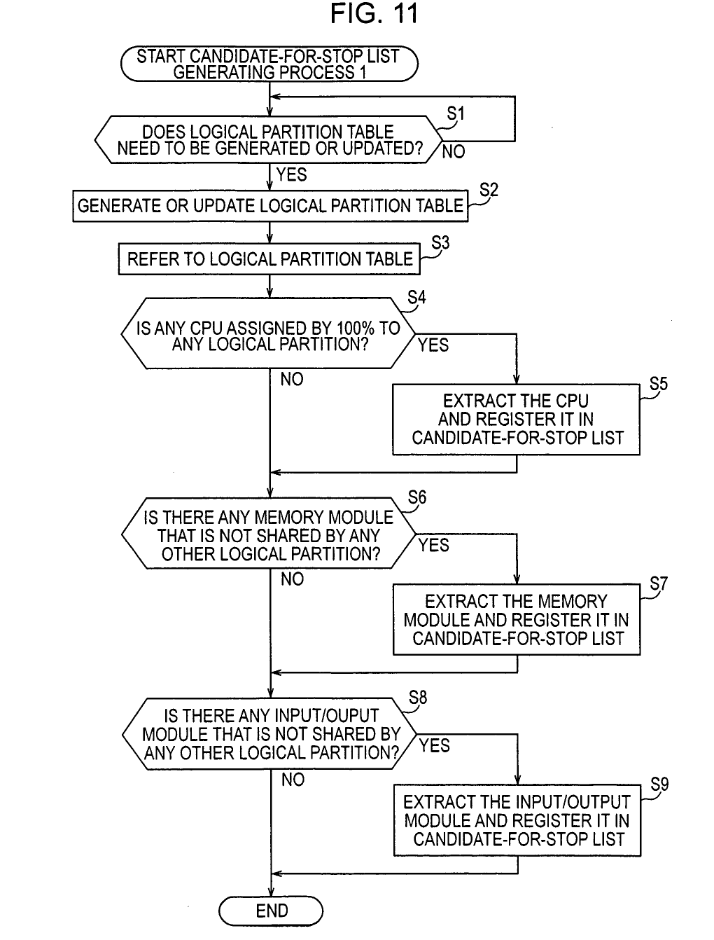

When the management application executed by the management application execution unit receives a state change request from the first operating system in a state where the plurality of operating systems are executed by the operating system execution unit, the management application may control an operation state of a set of the physical resources (e.g., resources registered in the candidate-for-stop list shown in FIG. 10) that is used by the first operating system and that is not used by the operating systems other than the first operating system that transmitted the state change request.

The management application executed by the management application execution unit may have a list generating function (e.g., a function executed by the candidate-for-stop list generating unit 63 in FIG. 5) of generating a list (e.g., the candidate-for-stop list in FIG. 10) of sets of the physical resources occupied by any of the operating systems in a state where the plurality of operating systems are executed by the operating system execution unit. When the management application receives a state change request from the first operating system in a state where the plurality of operating systems are executed by the operating system execution unit, the management application may refer to the list generated by the list generating function and control an operation state of the set of physical resources that is used by the first operating system and that is not used by the operating systems other than the first operating system that transmitted the state change request.

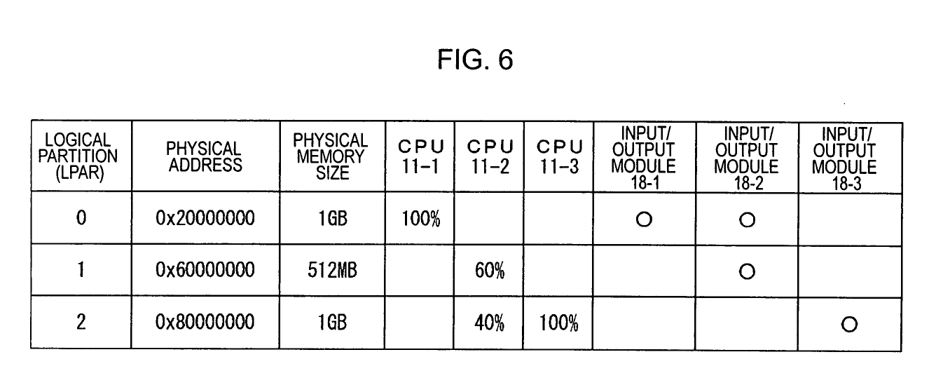

The management application executed by the management application execution unit may have a logical partitioning function of logically partitioning the physical resources and allowing respective sets of the physical resources to execute different processes. The management application may have a list generating function (e.g., a function executed by the logical partition table managing unit 62 in FIG. 5) of generating a list (e.g., the logical partition table in FIG. 6) of the sets of the physical resources used in respective logical partitions that are generated by the logical partitioning function in a state where the plurality of operating systems are executed by the operating system execution unit in the respective logical partitions. When the management application receives a state change request from the first operating system in a state where the plurality of operating systems are executed by the operating system execution unit, the management application may refer to the list generated by the list generating function and control an operation state of the set of physical resources only during a period assigned to be used by the first operating system in time division.

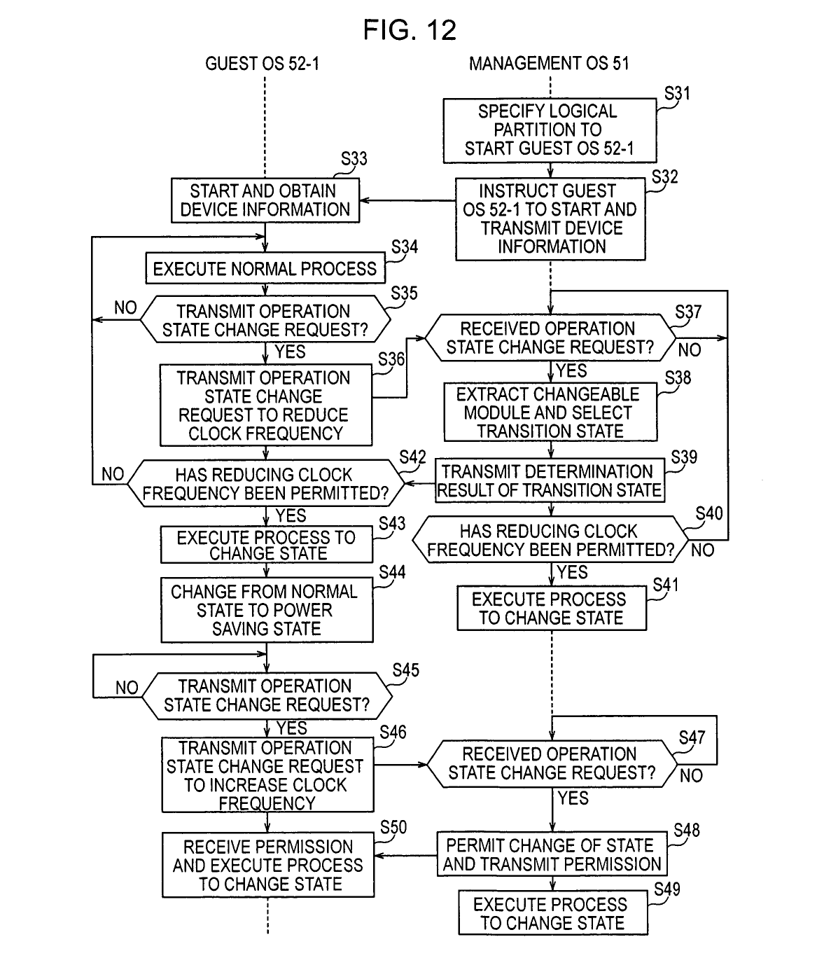

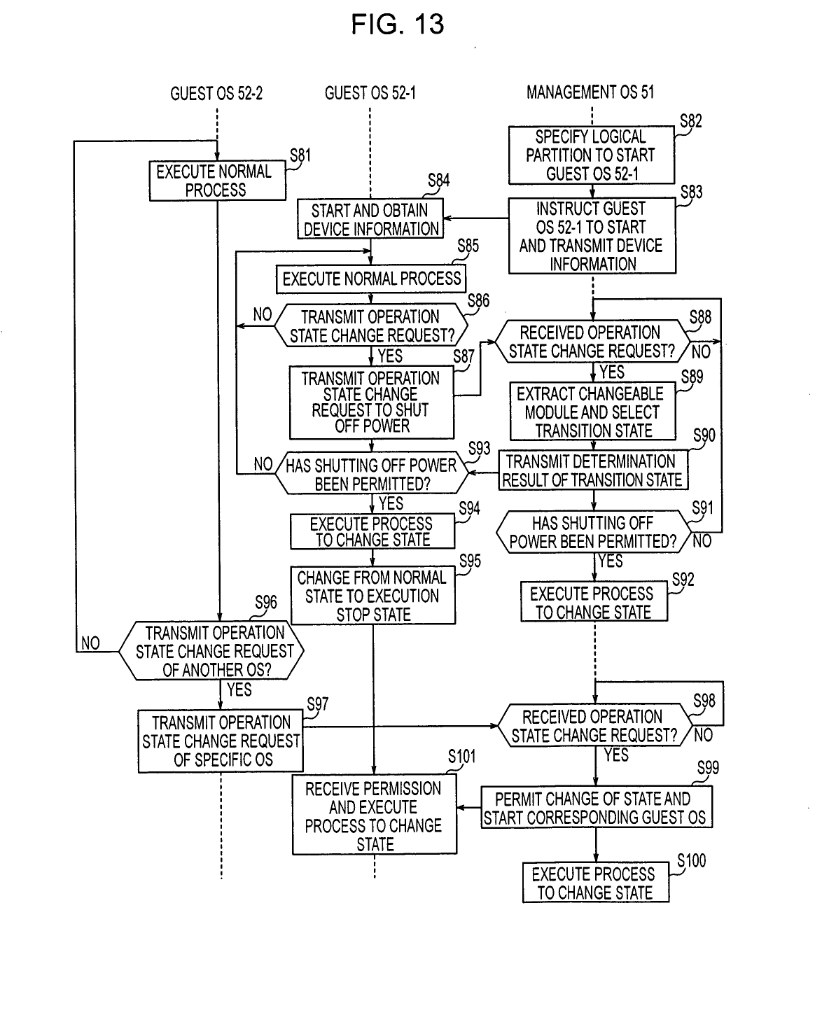

An information processing method according to an embodiment of the present invention is an information processing method for processing information by using a plurality of computing units (e.g., the CPUs 11 in FIG. 1). The information processing method includes the steps of: transmitting a state change request (e.g., a state change request to change an operation state) from a first operating system (e.g. the guest OS 52 in FIG. 5) executed by any of the plurality of computing units to a management application (e.g., the management OS 51) that manages an operation of the operating system (this step corresponds to, for example, step S36 in FIG. 12 or step S87 in FIG. 13); extracting a set of physical resources (e.g., the CPU 11, the memory module 14, and the input/output module 18 in FIG. 1) whose state can be controlled without causing an effect on a process of a second operating system that is executed in parallel with the first operating system based on the state change request transmitted in the transmitting step (this step corresponds to, for example, step S38 in FIG. 12 or step S89 in FIG. 13); and controlling a state of the set of physical resources extracted in the extracting step (this step corresponds to steps S39 to S44 in FIG. 12 or steps S90 to S95 in FIG. 13).

In a program according to an embodiment of the present invention, specific elements (only an example) corresponding to each step are the same as in the information processing method described above.

Hereinafter, an embodiment of the present invention is described with reference to the drawings.

First, a configuration of a computer system 1 according to an embodiment of the present invention is described with reference to FIG. 1. The computer system 1 may be composed of an apparatus or a plurality of apparatuses.

Respective central processing units (CPUs) 11-1 to 11-n have a logical partitioning (LPAR) function and connect to a system bus 12. That is, any one or a plurality of the CPUs 11-1 to 11-n can execute a management operating system (OS) for managing logical partitioning of the computer system 1 and operations of respective logical partitions, and also can execute guest operating systems (OSs) whose operation is managed by the management OS. The management OS executed by any of the CPUs 11-1 to 11-n has a Hypervisor privilege level capable of generating logical partitions and can issue a Hypervisor command that can be executed only with the Hypervisor privilege level.

The system bus 12 connects to a memory control module 13, an 10 (in/out) bridge 15, a management OS timer 16, and a user timer 17. Various devices other than those shown in FIG. 1 can be connected to the system bus 12. For example, an auxiliary processor or the like can be connected thereto.

The memory control module 13 controls write and read of data to/from memory modules 14-1 to 14-m. The memory control module 13 may include a cache control circuit and may incorporate or connect to a cache memory. The memory control module 13 assigns sequential physical addresses to all memory modules connected thereto, that is, the memory modules 14-1 to 14-m. Each of the memory modules 14-1 to 14-m includes at least a semiconductor recording device, such as a random access memory (RAM), and is configured such that power supply and an operation frequency can be controlled therein.

The 10 bridge 15 is a bridge to connect the system bus 12 to an 10 bus 25 and may have a translation control entry (TCE) mechanism described in Japanese Unexamined Patent Application Publication No. 2002-318701. The IO bus 25 connects to input/output modules 18-1 to 18-p, a power supply module 19, a clock supply module 20, a read only memory (ROM) 21, a hard disk drive (HDD) 22, and a drive 23.

The input/output modules 18-1 to 18-p include, for example, operation inputting devices or interface modules for the operation inputting devices, such as a keyboard, a mouse, a touch pad, a joystick, and a trackball for inputting an operation; a display device or a graphic interface such as a display; a voice outputting speaker module or sound interface; a network interface; or a disk controller for an external storage device.

The power supply module 19 supplies power to each unit of the computer system 1 or controls the supply of power, and is capable of supplying and stopping power to each unit of the compute system 1 and changing a supplied voltage based on the control by a process of the above-described management OS that is executed by any of the CPUs 11-1 to 11-n. The clock supply module 20 supplies clocks to each unit of the computer system 1 or controls the supply of clocks, and is capable of supplying and stopping clocks to each unit of the compute system 1 and changing a frequency of supplied clocks based on the control by a process of the above-described management OS that is executed by any of the CPUs 11-1 to 11-n.

The ROM 21 stores OSs that are respectively executed by any of the CPUs 11-1 to 11-n and application programs executed in those OSs. That is, the ROM 21 also stores the management OS. When the computer system 1 is started, the management OS stored in the ROM 21 is loaded and executed by any of the CPUs 11-1 to 11-n so as to generate at least one logical partition in the computer system 1. Accordingly, the management OS can execute guest OSs associated with the respective logical partitions.

The HDD 22 is capable of driving an internal hard disk and recording/reading various information. The hard disk can store OSs respectively executed in any of the CPUs 11-1 to 11-n, application programs executed in those OSs, data used by the OSs executed in any of the CPUs 11-1 to 11-n and by the application programs executed in those OSs, and data generated by the OSs and application programs.

Devices other than those shown in FIG. 1 may be connected to the 10 bus 25. Additionally, the devices may be connected to the IO bus 25 through a relay device.

The management OS timer 16 is a timer used by a process of the management OS and is not accessed from a guest OS and an application executed in the guest OS. Specifically, the management OS can generate a timer interrupt in the CPUs 11-1 to 11-n at predetermined time intervals by using the management OS timer 16. The user timer 17 is a timer that can be accessed from a guest OS or an application executed by the guest OS. The guest OS and the application executed by the guest OS can generate a timer interrupt in the CPUs 11-1 to 11-n at predetermined time intervals by using the user timer 17.

Hereinafter, each of the CPUs 11-1 to 11-n is referred to as a CPU 11 when they need not be distinguished from each other. Likewise, each of the memory modules 14-1 to 14-m is referred to as a memory module 14 when they need not be distinguished from each other, and each of the input/output modules 18-1 to 18-p is referred to as an input/output module 18 when they need not be distinguished from each other.

Next, the management OS and the guest OSs are described with reference to FIG. 2.

For example, assume a case where the CPU 11-4 executes the management OS and performs logical partitioning so as to generate logical partitions LPAR/0 to LPAR/2, and sets of resources assigned to respective OSs executed in the logical partitions LPAR/0 to LPAR/2 are the CPUs 11-1 to 11-3, the memory module 14, and the input/output modules 18-1 to 18-3.

In this case, logical partitioning is performed by the management OS executed by the CPU 11-4, so that the logical partitions LPAR/0 to LPAR/2 are generated. All resources that can be logically divided can be assigned to the logical partitions. For example, sets of resources assigned to the respective logical partitions include areas that do not overlap with each other in the physical memory space of the memory module 14, part or all of processing time of the respective CPUs 11 (hereinafter referred to as “CPU time”), and the input/output modules 18.

The management OS assigns a set of resources including the entire processing time of the CPU 11-1, part of the memory space of the memory module 14, the entire input/output module 18-1, and part of the processing time of the input/output module 18-2 to the logical partition LPAR/0. Also, the management OS assigns a set of resources including part of the processing time of the CPU 11-2, part of the memory space of the memory module 14, and part of the processing time of the input/output module 18-2 to the logical partition LPAR/1. Further, the management OS assigns a set of resources including part of the processing time of the CPU 11-2, the entire processing time of the CPU 11-3, part of the memory space of the memory module 14, and the input/output module 18-3 to the logical partition LPAR/2.

In other words, the CPU 11-1 is assigned to the logical partition LPAR/0 and executes a first OS executed in the logical partition LPAR/0. The CPU 11-2 is assigned to the logical partitions LPAR/1 and LPAR/2 and executes a second OS executed in the logical partition LPAR/1 and a third OS executed in the logical partition LPAR/2 in a time-division method with a predetermined time distribution. The CPU 11-3 is assigned to the logical partition LPAR/2 and executes the third OS executed in the logical partition LPAR/2 with the CPU 11-2.

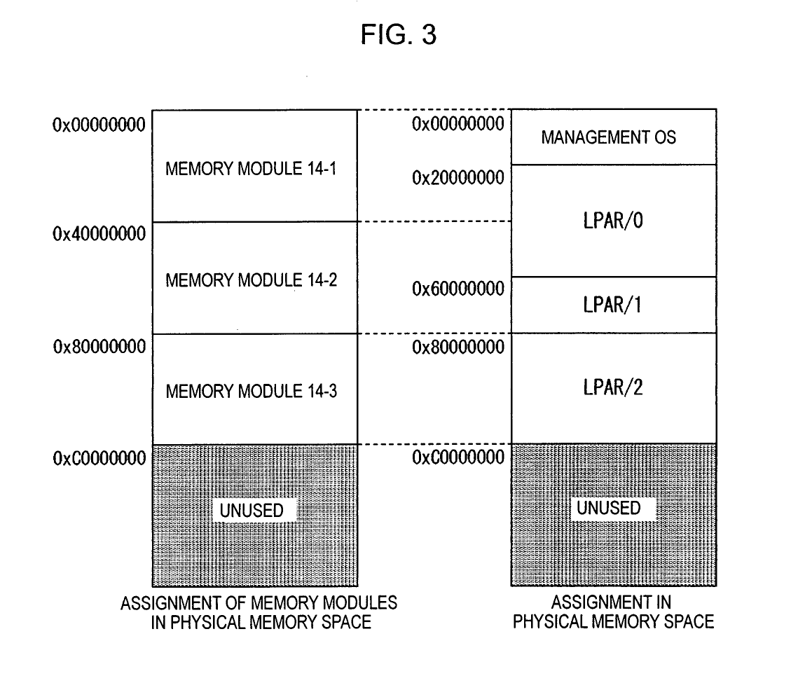

FIG. 3 shows an example of assignment in a physical memory space.

As shown in FIG. 3, storage areas of a plurality of memory modules (e.g., the memory modules 14-1 to 14-3) are assigned to one physical memory space, and the physical memory space is virtually distributed as a memory space to the management OS and a plurality of logical partitions (herein the LPAR/0, LPAR/1, and LPAR/2). The memory area assigned to the management OS can be exclusively used.

The input/output module 18-1 is assigned to the logical partition LPAR/0 and executes a process based on an application executed in the first OS executed in the logical partition LPAR/0. The input/output module 18-2 is assigned to the logical partitions LPAR/0 and LPAR/1 and executes both processes based on applications executed in the first OS executed in the logical partition LPAR/0 and the second OS executed in the logical partition LPAR/1. The input/output module 18-3 is assigned to the logical partition LPAR/2 and executes a process based on an application executed in the third OS executed in the logical partition LPAR/2.

Under such a condition where the sets of resources are assigned to the logical partitions, when an operation state change request, e.g., for stopping power supply to the set of resources assigned to the second OS, changing a supplied voltage, or changing a frequency of a supplied clock, is transmitted from the second OS executed in the logical partition LPAR/1 to the management OS because a user has not input any operation for a predetermined time period, the following problem may occur. That is, if power supply to the set of resources assigned to the logical partition LPAR/1 is stopped by controlling the power supply module 19 or if a clock frequency supplied to the set of resources assigned to the logical partition LPAR/1 is changed by controlling the clock supply module 20, a trouble may occur in the process of the first OS executed in the logical partition LPAR/0 or the third OS executed in the logical partition LPAR/2, or execution of the process may be hindered.

That is, the management OS needs to recognize the sets of resources assigned to the respective logical partitions. Also, when receiving an operation state change request from any of the guest OSs, the management OS needs to detect whether the set of resources assigned to a logical partition executing a process of the guest OS is shared with another logical partition and determine whether the operation state can be changed, e.g., whether power supply to the set of resources can be stopped, whether a supplied voltage can be changed, or whether a frequency of a supplied clock can be changed.

The management OS can effectively reduce power consumption by changing an operation state of a set of resources assigned to a logical partition where a guest OS is executed, in other words, an operation state of an element of the physical computer, in response to a request from the guest OS without affecting a process executed in another logical partition.

In the above description, the management OS is executed by one CPU 11-4 and the CPU 11-4 that executes the management OS does not execute any guest OS. However, the management OS may be executed by a plurality of CPUs. Also, the CPU 11 that executes the management OS may also execute a guest OS by using a time-division method or the like.

For example, as shown in FIG. 4, the CPU 11-4 may execute the management OS to generate the logical partitions LPAR/0 to LPAR/2. Also, predetermined ratios of the processing time of the CPU 11-4 may be assigned as sets of resources to respective OSs executed in the logical partitions LPAR/0 to LPAR/2. Further, the CPUs 11-1 to 11-3, the memory module 14, and the input/output modules 18-1 to 18-3 may be assigned.

Logical partitioning is performed by the management OS executed by the CPU 11-4, so that the logical partitions LPAR/0 to LPAR/2 are generated. As in the case described above with reference to FIG. 2, all resources that can be logically divided can be assigned to the logical partitions. For example, the resources assigned to the respective logical partitions include areas that do not overlap with each other in the physical memory space of the memory module 14, part or all of processing time of the CPUs 11, and the input/output modules 18.

The management OS assigns a set of resources including: part of the processing time of the CPU 11-4 in which the management OS is executed, the entire processing time of the CPU 11-1, part of the memory space of the memory module 14, the entire input/output module 18-1, and part of the processing time of the input/output module 18-2 to the logical partition LPAR/0. Also, the management OS assigns a set of resources including: part of the processing time of the CPU 11-4 in which the management OS is executed, part of the processing time of the CPU 11-2, part of the memory space of the memory module 14, and part of the processing time of the input/output module 18-2 to the logical partition LPAR/1. Also, the management OS assigns a set of resources including: part of the processing time of the CPU 11-4 in which the management OS is executed, part of the processing time of the CPU 11-2, the entire processing time of the CPU 11-3, part of the memory space of the memory module 14, and the input/output module 18-3 to the logical partition LPAR/2.

In other words, the CPU 11-1 is assigned to the logical partition LPAR/0 and can execute the first OS executed in the logical partition LPAR/0 together with the CPU 11-4. The CPU 11-2 is assigned to the logical partitions LPAR/1 and LPAR/2 and can execute the second OS executed in the logical partition LPAR/1 and the third OS executed in the logical partition LPAR/2 together with the CPU 11-4 in a time-division method with a predetermined time distribution. The CPU 11-3 is assigned to the logical partition LPAR/2 and can execute the third OS executed in the logical partition LPAR/2 together with the CPUs 11-2 and 11-4.

FIG. 5 is a functional block diagram showing functions that can be executed in the computer system 1 when the management OS is executed and logical partitioning is executed in the manner described with reference to FIG. 2, so that a plurality of logical partitions (herein the LPAR/0, LPAR/1, and LPAR/2) are generated. The assignment of the logical partitions in the following description is the same as that in the case shown in FIG. 2.

After the computer system 1 is started, a management OS 51 is executed. The management OS 51 has various functions described below which are realized by the following units: a guest OS management control unit 61, a logical partition table managing unit 62, a candidate-for-stop list generating unit 63, a candidate-for-stop list storage control unit 64, an interrupt control unit 65, a power supply control unit 66, a clock supply control unit 67, an OS switching context storage control unit 68, and a power controlling context storage control unit 69. The management OS 51 controls processes of guest OSs 52-1 to 52-3 executed in the respective logical partitions generated by logical partitioning.

Hereinafter, each of the guest OSs 52-1 to 52-3 is referred to as a guest OS 52 when they need not be distinguished from each other.

The guest OS management control unit 61 controls operations of the guest OSs 52-1 to 52-3 by using a logical partition table managed by a process of the logical partition table managing unit 62 and a candidate-for-stop list that is generated by the candidate-for-stop list generating unit 63 and that is stored by the candidate-for-stop list storage control unit 64 based on interrupt timing generated by the interrupt control unit 65. When the guest OS management control unit 61 receives an operation state change request to reduce power consumption from any of the guest OSs 52-1 to 52-3, the guest OS management control unit 61 detects whether a set of resources assigned to a logical partition executing a process of the guest OS that requested the change is shared with another logical partition and determines whether the operation state can be changed, that is, whether power supply to the set of resources can be stopped, whether the supplied voltage can be changed, or whether the frequency of the supplied clock can be changed, based on the logical partition table managed by the logical partition table managing unit 62, a module information table, and the candidate-for-stop list that is stored under the control by the candidate-for-stop list storage control unit 64. Then, the guest OS management control unit 61 notifies the power supply control unit 66 and the clock supply control unit 67 of the determination result.

The logical partition table managing unit 62 manages the logical partition table recorded in a memory area that can be exclusively used by the management OS 51. As described above with reference to FIG. 2, when the CPU 11-4 executes the management OS 51 to perform logical partitioning, the logical partitions LPAR/0 to LPAR/2 are generated. FIG. 6 shows a logical partition table in a case where the sets of resources assigned to respective OSs executed in the logical partitions LPAR/0 to LPAR/2 are the CPUs 11-1 to 11-3, the memory module 14, and the input/output modules 18-1 to 18-3.

In the logical partition table shown in FIG. 6, the logical partition LPAR/0 is assigned with a set of resources including an area of 1 GB starting from an address 0x20000000 in a physical memory space, 100% of the CPU time of the CPU 11-1, and the input/output modules 18-1 and 18-2. The logical partition LPAR/1 is assigned with a set of resources including an area of 512 MB starting from an address 0x50000000 in the physical memory space, 60% of the CPU time of the CPU 11-2, and the input/output module 18-2. The logical partition LPAR/2 is assigned with a set of resources including an area of 1 GB starting from an address 0x80000000 in the physical memory space, 40% of the CPU time of the CPU 11-2, 100% of the CPU time of the CPU 11-3, and the input/output module 18-3.

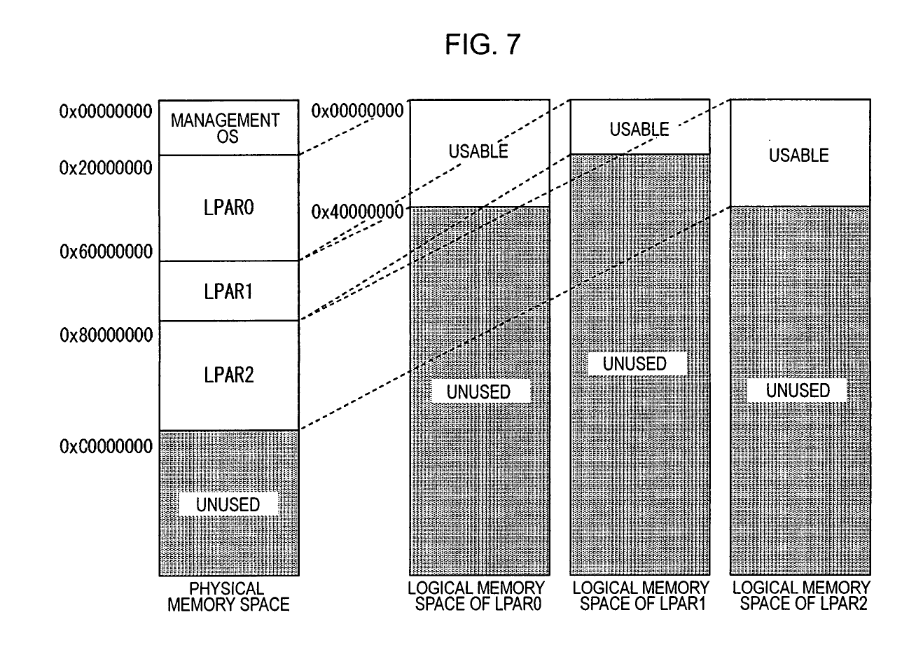

Herein, a logical address space is given to each logical partition. As shown in FIG. 7, the respective guest OSs 52 executed in the logical partitions recognize a logical address space as a physical address space, and a physical address range assigned to each logical partition is assigned from the top of the logical address space. The logical address can also be assigned to a virtual address if the guest OS 52 adequately sets an address converting mechanism of the CPU 11 and effectively uses it. Since the logical partition table is managed by the logical partition table managing unit 62, the management OS 51 can match the logical memory spaces and logical addresses recognized by the guest OSs 52 executed in the respective logical partitions with the physical memory spaces and physical addresses of the memory module 14.

The logical partition table is updated when a logical partitioning format or an executed guest OS is changed or when a physical module included in the computer system 1 is changed. Accordingly, the logical partition table managing unit 62 updates the logical partition table when a change in a logical partitioning format or an executed guest OS or a change in a set of resources to be assigned is transmitted from the guest OS management control unit 61.

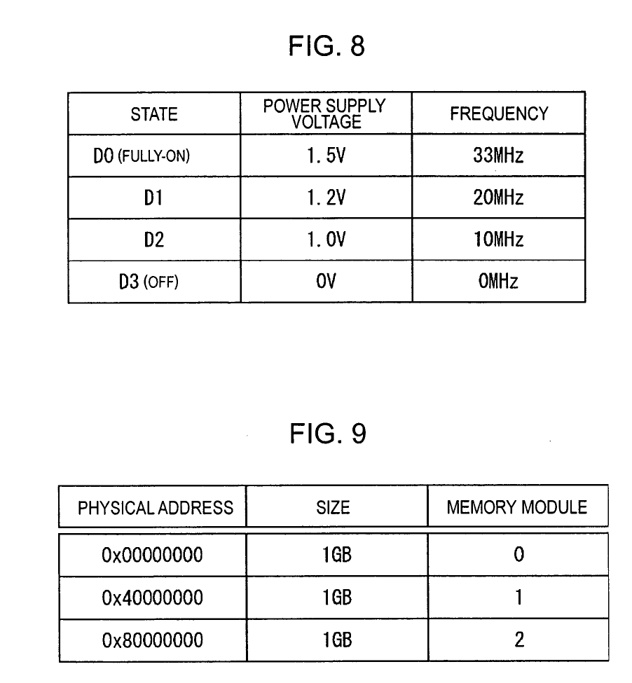

Further, the logical partition table managing unit 62 stores a module information table of each module shown in FIG. 1. FIG. 8 shows an example of the module information table of the input/output module 18 shown in FIG. 1. The device information includes information about a power supply voltage and a clock frequency in each operation state. In this case, the module information table indicates information such as a power supply voltage and a clock frequency in each operation state in accordance with the operation state based on an advanced configuration and power interface (ACPI) specification, which is used in a typical personal computer or a work station and various OSs executable therein. However, the operation state may not be based on the ACPI. By recognizing device information of each module, the management OS 51 selects an optimal state in accordance with a state change request from a guest OS, determines a state setting of a module assigned as a set of resources of the guest OS that requested a change of the state, and sets a power supply voltage or a clock frequency to be supplied. When there is no state that matches the state change request, a state of a higher operation level may be selected.

The candidate-for-stop list generating unit 63 extracts in advance one or more modules whose state can be change to a power saving mode or a power supply stop mode and generates a candidate-for-stop list by referring to the logical partition table managed by the logical partition table managing unit 62, and then supplies the generated candidate-for-stop list to the candidate-for-stop list storage control unit 64. Accordingly, when the guest OS management control unit 61 receives an operation state change request from any of the guest OSs that are controlled by the guest OS management control unit 61, power consumption can be limited without affecting the execution of the other guest OSs.

More specifically, the candidate-for-stop list generating unit 63 generates a list of resources that can be stopped in the logical partitions when the logical partitions are generated by logical partitioning, when the logical partitioning format or an executed OS is changed, and when a physical module included in the computer system 1 is changed.

The candidate-for-stop list generating unit 63 stores a memory configuration table shown in FIG. 9 in its internal memory. The memory configuration table shows physical addresses and storage capacities (sizes) of respective physical configurations of the memory module 14 (memory modules 14-1 to 14-3 in FIG. 9) when the entire memory module 14 is regarded as a single module.

The candidate-for-stop list generating unit 63 refers to the logical partition table to obtain information about the sets of resources assigned to the logical partitions. The candidate-for-stop list generating unit 63 detects whether any CPU 11 is assigned to any logical partition by 100%. If there is a CPU 11 that is assigned to any logical partition by 100%, the candidate-for-stop list generating unit 63 registers the CPU 11 in the candidate-for-stop list. Then, the candidate-for-stop list generating unit 63 checks the physical memory range assigned to each logical partition and detects whether the memory module 14 within the range is shared with another logical partition by referring to the memory configuration table shown in FIG. 9. If there is a memory module 14 that is not shared with another logical partition, the candidate-for-stop list generating unit 63 registers the memory module 14 in the candidate-for-stop list. Further, the candidate-for-stop list generating unit 63 detects whether there is any input/output module 18 that is assigned to only one logical partition, in other words, whether there is any input/output module 18 that is not shared by a plurality of logical partitions. If there is an input/output module 18 that is not shared by a plurality of logical partitions, the candidate-for-stop list generating unit 63 registers the input/output module 18 in the candidate-for-stop list.

FIG. 10 shows an example of a candidate-for-stop list in a case where the CPU 11-4 executes the management OS to generate the logical partitions LPAR/0 to LPAR/2 and sets of resources are assigned to the respective OSs executed in the logical partitions LPAR/0 to LPAR/2, as described above with reference to FIG. 2. In the candidate-for-stop list shown in FIG. 10, the CPU 11-1, the input/output module 18-1, and the memory module 14-1, which are exclusively assigned to the logical partition LPAR/0, are registered. On the other hand, nothing is registered as for the logical partition LPAR/1 because no resource is exclusively assigned to the logical partition LPAR/1. Also, the CPU 11-3, the input/output module 18-3, and the memory module 14-3, which are exclusively assigned to the logical partition LPAR/2, are registered. The details of a process of generating the list will be described later.

The candidate-for-stop list is updated when the logical partitioning format or an executed guest OS is changed or when a physical module included in the computer system 1 is changed, as in the logical partition table. Specifically, the candidate-for-stop list generating unit 63 updates the candidate-for-stop list when a change in the logical partitioning format or an executed OS or a change in the assigned resources is transmitted from the guest OS management control unit 61.

The candidate-for-stop list storage control unit 64 controls storage of the supplied candidate-for-stop list in a memory area that can be exclusively used by the management OS.

The interrupt control unit 65 generates a timer interrupt at predetermined timing based on count by the management OS timer 16. For example, when any set of resources, e.g., the CPU 11, is shared by a plurality of logical partitions by a process of the guest OS management control unit 61, in other words, when less than 100% of the CPU time of any CPU 11 is assigned to any of the logical partitions, the interrupt control unit 65 is called at predetermined time intervals by the interrupt from the management OS timer 16, measures elapsed time, and controls switching of the logical partitions using the CPU 11 every time the predetermined time assigned to each logical partition elapses.

The power supply control unit 66 controls power supply from the power supply module 10 to each unit of the computer system 1. More specifically, when power supply to a set of resources assigned to any logical partition is controlled by the process described later, the power supply control unit 66 controls the power supply module 19 so as to stop power supply to the specific set of resources or to control the power supply voltage.

The clock supply control unit 67 controls supply of clocks from the clock supply module 20 to each unit of the computer system 1. More specifically, when supply of clocks to a set of resources assigned to any logical partition is controlled by the process described later, the clock supply control unit 67 controls the clock supply module 20 so as to stop supply of clocks to the specific set of resources or to change the supplied clock frequency.

The OS switching context storage control unit 68 controls recording of an execution state of a CPU 11 in the memory module 14 when the process of the CPU 11 is interrupted and also controls reading and recovery of the execution state when the state is recovered, in order to execute the process in the logical partition that is switched by a timer interrupt generated by the interrupt control unit 65 in a time division process, which is executed when one CPU 11 is shared by a plurality of logical partitions, in other words, when less than 100% of the CPU time of one CPU 11 is assigned to any logical partition by the process of the guest OS management control unit 61. In a state where the input/output module 18 is shared by a plurality of logical partitions and where an execution state of a process of the guest OS 52 executed in one of the logical partitions should be stored, when the process of the CPU 11 is changed to a process of another guest OS 52 that is executed in another logical partition, the OS switching context storage control unit 68 controls recording of the execution state of the input/output module 18 in the memory module 14 and also controls reading and recovery of the execution state when the state is recovered.

When power supply to any set of resources registered in the candidate-for-stop list, which is generated by the candidate-for-stop list generating unit 63 and which is stored under the control by the candidate-for-stop list storage control unit 64, is stopped and the context needs to be saved to control power by a process of the guest OS management control unit 61 in response to a state change request from any guest OS, the power controlling context storage control unit 69 saves the context, such as any processing state of the CPU 11 that is executed by the guest OS, controls storage of the context in an external storage device connected to the HDD 22 or the input/output module 18, and controls reading and recovery of the context when the state is recovered.

Next, a function of the guest OS 52 is described. The guest OS 52-1 is executed in the logical partition LPAR/0, the guest OS 52-2 is executed in the logical partition LPAR/1, and the guest OS 52-3 is executed in the logical partition LPAR/2.

The guest OSs 52-1 to 52-3 have the following various functions realized by information processing units 81-1 to 81-3, memory control units 82-1 to 82-3, and ACPI control units 83-1 to 83-3, respectively.

The information processing units 81-1 to 81-3 execute processes of the respective guest OSs 52-1 to 52-3 or processes of application programs executed therein.

The memory control units 82-1 to 82-3 control storage of execution states of processes of the respective guest OSs 52-1 to 52-3 or the application programs executed therein, and storage of data required or generated in those processes.

The ACPI control units 83-1 to 83-3 control operation state control functions of the guest OSs 52-1 to 52-3. When an interrupt from an input module assigned to any of the guest OSs 52-1 to 52-3 does not occur for a predetermined period, e.g., when a user does not input any operation for a predetermined period, the operation state control function transmits an operation state change request to the management OS 51 in order to reduce the operation speed of the resources of the corresponding logical partition, to stop the operation, or to turn off the power. The ACPI control units 83-1 to 83-3 controls the operation states based on the advanced configuration and power interface (ACPI) specification, which is used in typical personal computers, work stations, and various OSs executable in those apparatuses. In the computer system 1 according to an embodiment of the present invention, the management OS 51 receives an operation state change request based on the ACPI transmitted from the guest OSs 52-1 to 52-3 having the operation state control function based on the ACPI. In response to the request, the management OS 51 can control the operations of the various modules included in the computer system 1.

In this embodiment, all of the guest OSs 52-1 to 52-3 executed in the respective logical partitions have the operation state control function based on the ACPI. However, not all of the guest OSs 52-1 to 52-3 may have the operation state control function based on the ACPI. Further, an operation setting of the operation state control function can be individually set by the guest OSs 52-1 to 52-3 while being independent from the management OS 51. For example, the operation state control function can be disabled by a setting operation by a user.

Hereinafter, each of the information processing units 81-1 to 81-3 is referred to as an information processing unit 81 when they need not be distinguished from each other, each of the memory control units 82-1 to 82-3 is referred to as a memory control unit 82 when they need not be distinguished from each other, and each of the ACPI control units 83-1 to 83-3 is referred to as an ACPI control unit 83 when they need not be distinguished from each other.

Now, operations performed by the management OS 51 to control the guest OSs 52-1 to 52-3 executed in the logical partitions, which are generated by logical partitioning, are described with reference to flowcharts.

First, a candidate-for-stop list generating process 1 is described with reference to the flowchart shown in FIG. 11.

In step S1, the logical partition table managing unit 62 determines whether a logical partition table needs to be generated or updated based on whether a logical partitioning format or an executed guest OS has been changed and whether a physical module included in the computer system 1 has been changed. When it is determined in step 1 that a logical partition table need not be generated or updated, step S1 is repeated until it is determined that a logical partition table needs to be generated or updated.

When it is determined in step S1 that a logical partition table needs to be generated or updated, the process proceeds to step S2 where the logical partition table managing unit 62 generates or updates the logical partition table by obtaining information about a format of the present logical partitioning, executed guest OSs, and physical modules included in the computer system 1.

In step S3, the candidate-for-stop list generating unit 63 refers to the logical partition table that was generated or updated in step S2.

In step S4, the candidate-for-stop list generating unit 63 determines whether any CPU 11 is assigned by 100% to any logical partition by referring to the logical partition table.

When it is determined in step S4 that there is a CPU 11 that is assigned by 100% to any logical partition, the process proceeds to step S5 where the candidate-for-stop list generating unit 63 extracts the CPU 11 that is assigned by 100% to any logical partition and registers the CPU 11 in the candidate-for-stop list.

When it is determined in step S4 that no CPU 11 is assigned by 100% to any logical partition, or after step S5, the process proceeds to step S6 where the candidate-for-stop list generating unit 63 determines whether there is a memory module 14 that is not shared by any other logical partition by referring to the logical partition table.

When it is determined in step S6 that there is a memory module 14 that is not shared by any other logical partition, the process proceeds to step S7 where the candidate-for-stop list generating unit 63 extract the memory module 14 that is not shared by any other logical partition and registers it in the candidate-for-stop list.

When it is determined in step S6 that there is no memory module 14 that is not shared by any other logical partition, or after step S7, the process proceeds to step S8 where the candidate-for-stop list generating unit 63 determines whether there is an input/output module 18 that is not shared by any other logical partition by referring to the logical partition table.

When it is determined in step S8 that there is an input/output module 18 that is not shared by any other logical partition, the process proceeds to step S9 where the candidate-for-stop list generating unit 63 extracts the input/output module 18 that is not shared by any other logical partition and registers it in the candidate-for-stop list.

When it is determined in step S8 that there is no input/output module 18 that is not shared by any other logical partition, or after step S9, the process ends.

In the above-described process, the candidate-for-stop list shown in FIG. 10 is generated and the storage thereof is controlled by the candidate-for-stop list storage control unit 64.

Next, a process performed when the guest OS 52-1 is executed in the logical partition LPAR/0 and when an operation state change request of reducing a clock frequency is made is described with reference to the flowchart shown in FIG. 12.

In step S31, the management OS 51 specifies the logical partition LPAR/0 to start the guest OS 52-1.

In step S32, the management OS 51 instructs the guest OS 52-1 to start and transmits device information assigned to the logical partition LPAR/0 to the guest OS 52-1. Herein, the management OS 51 starts a new guest OS in a new logical partition, and thus executes the candidate-for-stop list generating process 1 described above with reference to FIG. 11 so as to newly generate or update a candidate-for-stop list.

In step S33, the guest OS 52-1 starts and obtains the assigned device information in accordance with the control by the management OS 51.

In step S34, the guest OS 52-1 executes a normal process, e.g., executes an application program based on an operation input by a user.

In step S35, the guest OS 52-1 determines whether to transmit an operation state change request to the management OS 51, e.g., whether the user has not input any operation for more than a predetermined time period. When it is determined in step S35 that an operation state change request should not be transmitted, the process returns to step S34 and the subsequent steps are repeated.

When it is determined in step S35 that an operation state change request should be transmitted, the process proceeds to step S36 where the guest OS 52-1 transmits an operation state change request to reduce a clock frequency to the management OS 51.

In step S37, the management OS 51 determines whether the management OS 51 has received an operation state change request from any of the guest OSs (in this case from the guest OS 52-1). When it is determined in step S37 that the management OS 51 has not received an operation state change request, step S37 is repeated until it is determined that the management OS 51 has received an operation state change request.

When it is determined in step S37 that the management OS 51 has received an operation state change request, the process proceeds to step S38 where the management OS 51 extracts a module whose state can be changed in accordance with the change in the operation state of the guest OS (herein the guest OS 52-1) that has transmitted the operation state change request, by referring to the logical partition table managed by the logical partition table managing unit 62 and by referring to the candidate-for-stop list that is stored under the control by the candidate-for-stop list storage control unit 64. Also, the management OS 51 selects a transition state of the module whose state can be changed by referring to the module information table of each module stored by the logical partition table managing unit 62.

More specifically, the management OS 51 extracts candidate modules to be stopped in the guest OS 52-1 that has transmitted the operation state change request, i.e., the CPU 11-1, the input/output module 18-1, and the memory module 14-1, by referring to the candidate-for-stop list shown in FIG. 10. Then, the management OS 51 selects a transition state of the modules whose state can be changed in response to the operation state change request to reduce the clock frequency by referring to the module information table of each module stored by the logical partition table managing unit 62 as shown in FIG. 8.

In step S39, the management OS 51 notifies the guest OS that has transmitted the operation state change request (herein the guest OS 52-1) of the determination result of the transition state.

In step S40, the management OS 51 determines whether reducing the clock frequency of any module has been permitted by step S38. When it is determined in step S40 that reducing the clock frequency of any module has not been permitted, the process returns to step S37 and the subsequent steps are repeated.

When it is determined in step S40 that reducing the clock frequency of any module has been permitted, the process proceeds to step S41 where the management OS 51 controls a process required to change the state. Specifically, the management OS 51 controls a process of determining whether the information recorded in the memory module 14 includes information to be saved, obtaining the information to be saved if any, and storing the information in any of the HDD 22 and an external storage device connected to the input/output module 18 as necessary.

On the other hand, the guest OS 52-1 determines whether reducing the clock frequency of any module has been permitted in step S42. When it is determined in step S42 that reducing the clock frequency of any module has not been permitted, the process returns to step S34 and the subsequent steps are repeated.

When it is determined in step S42 that reducing the clock frequency of any module has been permitted, the process proceeds to step S43 where the guest OS 52-1 executes a process required to change the state. Specifically, the guest OS 52-1 outputs information to be saved under the control by the management OS 51. Then, the process proceeds to step S44 where the guest OS 52-1 changes the state of the specified module from a normal processing state to a power saving operation state under the control by the management OS 51.

Then, the process proceeds to step S45 where the guest OS 52-1 determines whether to transmit a request for changing the operation state from the power saving state to the normal operation state to the management OS 51, e.g., when receiving an operation input by the user. When it is determined in step S45 that an operation state change request should not be transmitted, step 45 is repeated until it is determined to transmit an operation state change request.

When it is determined in step S45 that an operation state change request should be transmitted, the process proceeds to step S46 where the guest OS 52-1 transmits an operation state change request to increase the clock frequency to the management OS 51.

On the other hand, the management OS 51 determines whether the management OS 51 has received an operation state change request from any of the guest OSs (herein the guest OS 52-1) in step S47. When it is determined in step S47 that an operation state change request has not been received, step S47 is repeated until it is determined that an operation state change request has been received.

When it is determined in step S47 that an operation state change request has been received, the process proceeds to step S48 where the guest OS 51 permits change of the state and transmits the permission to the guest OS that has transmitted the operation state change request (herein the guest OS 52-1).

In step S49, the management OS 51 executes a process required to change the state. Specifically, the management OS 51 increases the clock frequency of the set of resources whose clock frequency has been reduced among the resources assigned to the logical partition LPAR/0 to the normal state and controls recovery of the saved information.

In step S50, the guest OS 52-1 receives the permission of changing the state and executes a process required to change the state. Specifically, the guest OS 52-1 obtains the saved information under the control by the management OS 51 and expands the information in the memory module 14. Then, the process ends.

As described above, by using the ACPI-compatible function of the guest OS 52-1 of issuing a state change request to reduce power consumption, the management OS 51 changes the state to a power saving operation state in order to reduce power consumption by reducing the clock frequency of a module while preventing an effect on the process of the other guest OSs, by referring to the logical partition table, the candidate-for-stop list, and the module information table. Further, when receiving another operation state change request from the guest OS 52-1, the management OS 51 increases the clock frequency of the set of resources whose clock frequency has been reduced among the resources assigned to the logical partition LPAR/0 to the normal state, so that the normal operation state can be recovered.

Incidentally, if the operation state of any of the guest OSs 52 is changed to a power supply stop state, it is difficult for that guest OS 52 to request recovery of the state to the management OS 51 by itself.

For this reason, at least one of the guest OSs 52 or an application program that is operable in at least one of the guest OSs 52 has a Hypervisor calling function of requesting restart of the execution of another guest OS 52 that is in a power supply stop state. The guest OS 52 having the Hypervisor calling function or an application program having the Hypervisor calling function provides a user interface used by the user to input a command of restarting execution of the pausing guest OS 52. The guest OS 52 having the Hypervisor calling function of requesting restart of execution of the pausing guest OS 52 to the management OS 51 or the guest OS 52 in which an application program having this function is executed receives an execution restart command from the user and requests restart of execution of the pausing guest OS 52 to the management OS 51 by using the Hypervisor calling function.

Additionally, the user interface used by the user to input a command of restarting execution of the pausing guest OS 52 should be protected so that only an administrator of the computer system 1 can operate it.

The flowchart shown in FIG. 13 illustrates a process that is performed when the guest OS 52-2 executes Hypervisor calling to request restart of execution of the pausing guest OS 52-1 to the management OS 51.

In step S81, the guest OS 52-2 executes a normal process.

In steps S82 to S85, the management OS 51 and the guest OS 52-1 executes the same process as in steps S31 to S34 shown in FIG. 12. That is, the management OS 51 specifies the logical partition LPAR/0 to start the guest OS 52-1, instructs the guest OS 52-1 to start, and transmits device information assigned to the logical partition LPAR/0. Then, the guest OS 52-1 starts and obtains the assigned device information under the control by the management OS 51 and executes a normal process, e.g., executes an application program, based on an operation input by the user.

In step S86, the guest OS 52-1 determines whether to transmit an operation state change request to shut off the power to the management OS 51, e.g., when any operation is not input by the user for more than a predetermined time period. When it is determined in step S86 that an operation state change request should not be transmitted, the process returns to step S85 and the subsequent steps are repeated.

When it is determined in step S86 that an operation state change request should be transmitted, the process proceeds to step S87 where the guest OS 52-1 transmits an operation state change request to shut off the power to the management OS 51.

In step S88, the management OS 51 determines whether the management OS 51 has received an operation state change request from any of the guest OSs (herein the guest OS 52-1). When it is determined in step S88 that no operation state change request has been received, step S88 is repeated until it is determined that an operation state change request has been received.

When it is determined in step S88 that the management OS 51 has received an operation state change request, the process proceeds to step S89 where the management OS 51 extracts a module whose state can be changed in accordance with the change in the operation state of the guest OS (herein the guest OS 52-1) that has transmitted the operation state change request, by referring to the logical partition table managed by the logical partition table managing unit 62 and by referring to the candidate-for-stop list that is stored under the control by the candidate-for-stop list storage control unit 64. Also, the management OS 51 selects a transition state of the module whose state can be changed by referring to the module information table of each module stored by the logical partition table managing unit 62.

More specifically, the management OS 51 extracts candidate modules to be stopped in the guest OS 52-1 that has transmitted the operation state change request, i.e., the CPU 11-1, the input/output module 18-1, and the memory module 14-1, by referring to the candidate-for-stop list shown in FIG. 10. Then, the management OS 51 selects a transition state of the modules whose state can be changed in response to the operation state change request to shut off power by referring to the module information table of each module stored by the logical partition table managing unit 62 as shown in FIG. 8.

In step S90, the management OS 51 notifies the guest OS that has transmitted the operation state change request (herein the guest OS 52-1) of the determination result of the transition state.

In step S91, the management OS 51 determines whether shutting off the power of any module has been permitted by step S89. When it is determined in step S91 that shutting off the power of any module has not been permitted, the process returns to step S88 and the subsequent steps are repeated.

When it is determined in step S91 that shutting of the power of any module has been permitted, the process proceeds to step S92 where the management OS 51 controls a process required to change the state. Specifically, the management OS 51 controls a process of determining whether the information recorded in the memory module 14 includes information to be saved, obtaining the information to be saved if any, and storing the information in any of the HDD 22 and an external storage device connected to the input/output module 18 as necessary.

On the other hand, the guest OS 52-1 determines whether shutting off the power of any module has been permitted in step S93. When it is determined in step S93 that shutting off the power of any module has not been permitted, the process returns to step S85 and the subsequent steps are repeated.

When it is determined in step S93 that shutting off the power of any module has been permitted, the process proceeds to step S94 where the guest OS 52-1 executes a process required to change the state. Specifically, the guest OS 52-1 outputs information to be saved under the control by the management OS 51. Then, the process proceeds to step S95 where the guest OS 52-1 changes the state of the specified module from a normal processing state to an execution stop state under the control by the management OS 51.

Then, the process proceeds to step S96 where the guest OS 52-2 determines whether to transmit an operation state change request to the management OS 51 in order to change the operation state of another guest OS (herein the guest OS 52-1) from the execution stop state to the normal operation state based on an operation input by the user. When it is determined in step S96 that an operation state change request should not be transmitted, the process returns to step S81 and steps S81 to S96 are repeated until the guest OS 52-2 determines to transmit an operation state change request.

When it is determined in step S96 that an operation state change request should be transmitted, the process proceeds to step S97 where the guest OS 52-2 transmits an operation state change request to the management OS 51 in order to change the operation state of the specific guest OS (herein the guest OS 52-1) from the execution stop state to the normal operation state.

On the other hand, the management OS 51 determines whether the management OS 51 has received an operation state change request from any of the guest OSs (herein the guest OS 52-2) in step S98. When it is determined in step S98 that no operation state change request has been received, step S98 is repeated until it is determined that an operation state change request has been received.

When it is determined in step S98 that an operation state change request has been received, the process proceeds to step S99 where the guest OS 51 permits change of the state and starts the guest OS in which the operation state is to be changed (herein the guest OS 52-1).

In step S100, the management OS 51 executes a process required to change the state. Specifically, the management OS 51 supplies power to a set of resources in which the power is shut off among the resources assigned to the logical partition LPAR/0 used by the guest OS 52-1 and controls recovery of the saved information.

In step S101, the guest OS 52-1 receives the permission of changing the state and executes a process required to change the state. Specifically, the guest OS 52-1 obtains the saved information under the control by the management OS 51 and expands the information in the memory module 14. Then, the process ends.

As described above, by using the ACPI-compatible function of the guest OS 52-1 of issuing a state change request to reduce power consumption, the management OS 51 changes the state to an execution stop state in order to reduce power consumption by shutting off the power supply to a module while preventing an effect on the process of the other guest OSs, by referring to the logical partition table, the candidate-for-stop list, and the module information table. Further, when receiving another operation state change request from a guest OS other than the guest OS 52-1, e.g., the guest OS 52-2, the management OS 51 supplies power to the set of resources in which the power supply has been shut off among the resources used by the pausing guest OS 52-1, that is, the resources assigned to the logical partition LPAR/0, so that the normal operation state can be recovered.

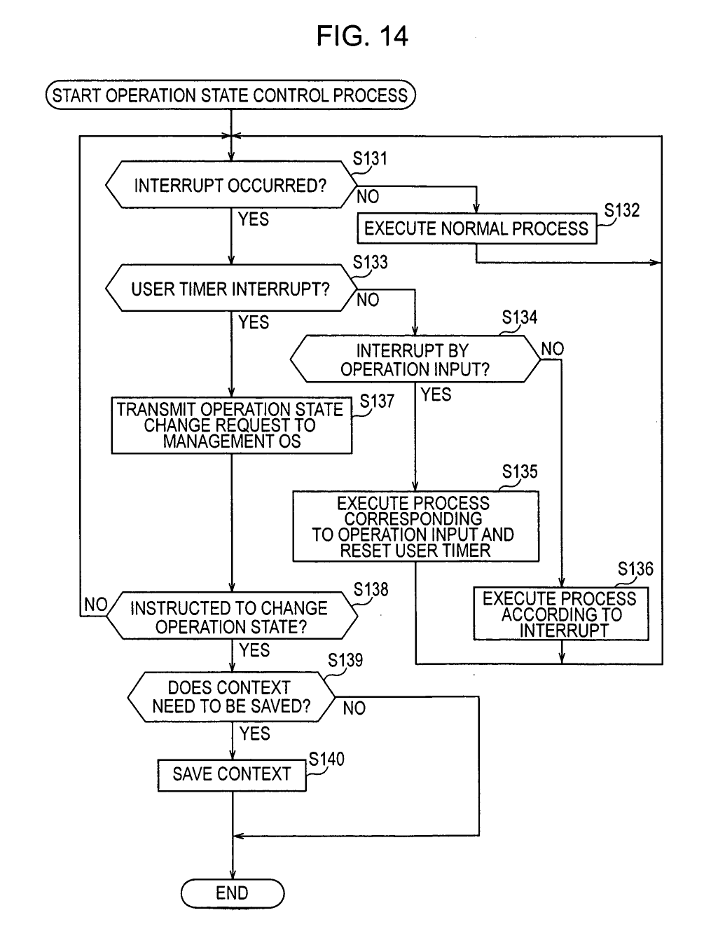

Next, an operation state control process performed by the guest OS 52 is described with reference to the flowchart shown in FIG. 14. This process corresponds to steps S35, S36, S42, and S43 in FIG. 12 or steps S86, S87, S93, and S94 in FIG. 13.

In step S131, the information processing unit 81 of the guest OS 52 determines whether an interrupt has occurred.

When it is determined in step S131 that an interrupt has not occurred, the process proceeds to step S132 where the information processing unit 81 executes a normal process. Then, the process returns to step S131 and the subsequent steps are repeated.

When it is determined in step S131 that an interrupt has occurred, the process proceeds to step S133 where the information processing unit 81 determines whether the occurred interrupt is a user timer interrupt counted by the user timer 17 (FIG. 1), that is, an interrupt that occurred because no operation has been input by the user for a predetermined time period.

When it is determined in step S133 that the occurred interrupt is not a user timer interrupt, the process proceeds to step S134 where the information processing unit 81 determines whether the interrupt is an interrupt by an operation input.

When it is determined in step S134 that the interrupt is an interrupt by an operation input, the process proceeds to step S135 where the information processing unit 81 executes a process corresponding to the operation input and resets the user timer 17.

When it is determined in step S134 that the occurred interrupt is an interrupt caused by a control command or the like from the management OS other than an operation input, the process proceeds to step S136 where the information processing unit 81 executes a process according to the interrupt. After step S135 or S136, the process returns to step S131, and the subsequent steps are repeated.

When it is determined in step S133 that the occurred interrupt is a user timer interrupt, the process proceeds to step S137 where the information processing unit 81 notifies the ACPI control unit 83 of the occurrence of the user timer interrupt. In response to this, the ACPI control unit 83 transmits an operation state change request to reduce a clock frequency or to shut off the power to the management OS 51. This step corresponds to step S36 in FIG. 12 or step S87 in FIG. 13, for example.

In step S138, the information processing unit 81 determines whether the information processing unit 81 has been instructed by the management OS 51 to change the operation state. When it is determined in step S138 that the information processing unit 81 has not been instructed to change the operation state, the process returns to step S131 and the subsequent steps are repeated.

When it is determined in step S138 that the information processing unit 81 has been instructed to change the operation state, the process proceeds to step S139 where the information processing unit 81 determines whether the context needs to be saved before changing the operation state.

When it is determined in step S139 that the context needs to be saved, the process proceeds to step S140 where the information processing unit 81 saves the context in which the storage is controlled by the process of the memory control unit 82 in the HDD 22 or the like.

When it is determined in step S139 that the context does not need to be saved, or after step S140, the process ends.

By performing the above-described process, the guest OS 52 can transmit an operation state change request to the management OS so that change of the operation state can be controlled based on the ACPI. When the guest OS 52 is instructed by the management OS to change the operation state, a necessary process of saving the context and the like is executed and then the operation state is changed.

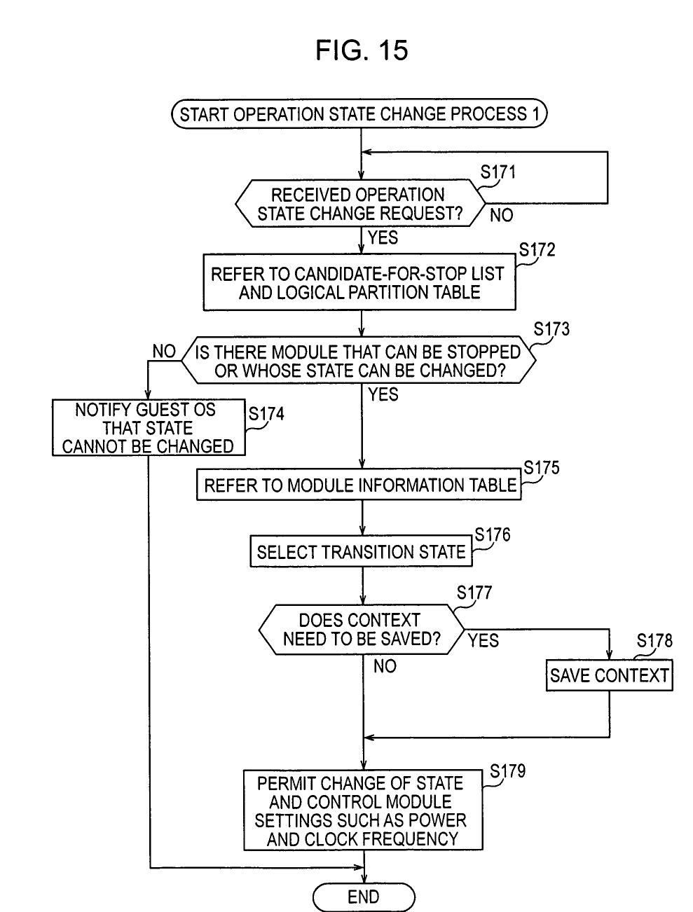

Next, an operation state change process 1 is described with reference to the flowchart shown in FIG. 15. This process is executed by the management OS 51 in response to an operation state change request to reduce power consumption and corresponds to steps S37 to S41 in FIG. 12 or steps S88 to S92 in FIG. 13.

In step S171, the guest OS management control unit 61 determines whether the guest OS management control unit 61 has received an operation state change request from any of the guest OSs 52. When it is determined in step S171 that the guest OS management control unit 61 has not received an operation state change request, step S171 is repeated until it is determined that the guest OS management control unit 61 has received an operation state change request.

When it is determined in step S171 that an operation state change request has been received, the process proceeds to step S172 where the guest OS management control unit 61 refers to the candidate-for-stop list that is generated by the candidate-for-stop list generating unit 63 and that is stored under the control by the candidate-for-stop list storage control unit 64 and the logical partition table managed by the logical partition table managing unit 62.

In step S173, the guest OS management control unit 61 determines whether the modules assigned to the logical partition where the guest OS 52 that has transmitted the operation state change request is executed include a module that can be stopped or whose state can be changed based on the candidate-for-stop list and the logical partition table.

When it is determined in step S173 that there is no module that can be stopped or whose state can be changed, the process proceeds to step S174 where the guest OS management control unit 61 notifies the guest OS 52 that has transmitted the operation state change request that the state cannot be changed, and then the process ends.

When it is determined in step S173 that there is a module that can be stopped or whose state can be changed, the process proceeds to step S175 where the guest OS management control unit 61 refers to the module information table corresponding to the module that can be stopped or whose state can be changed, the table being managed by the logical partition table managing unit 62.

In step S176, the guest OS management control unit 61 selects a transition state to change the state based on the module information table that was referred to in step S175.

More specifically, when the operation state change request is for shutting off the power and when there is a module that can be stopped, that is, a module used by the corresponding guest OS 52 by 100% in the candidate-for-stop list, the guest OS management control unit 61 stops power supply to the module. When the operation state change request is for switching to a power saving mode by reducing the clock frequency and when there is a module used by the corresponding guest OS 52 by 100%, the guest OS management control unit 61 reduces the clock frequency supplied to the module. When there is no module used by the corresponding guest OS 52 by 100% regardless of the type of operation state change request, the power consumption can be reduced by controlling power or clock frequency to be supplied only during a time period assigned by a time division process.

In step S177, the guest OS management control unit 61 determines whether the context needs to be saved in the guest OS 52 whose state is to be changed.

When it is determined in step S177 that the context needs to be saved, the process proceeds to step S178 where the guest OS management control unit 61 notifies the power controlling context storage control unit 69 that the context needs to be saved, so that the power controlling context storage control unit 69 saves the context of the guest OS 52 whose state is to be changed.

When it is determined in step S177 that the context does not need to be saved, or after step S178, the process proceeds to step S179 where the guest OS management control unit 61 transmits a permission of changing the state to the guest OS 52 that has transmitted the state change request. Also, the guest OS management control unit 61 controls settings of power and a clock frequency of the module in which change of the state is permitted among the modules assigned to the logical partition where the guest OS 52 that has transmitted the operation state change request is executed, by using the process of the power supply control unit 66 or the clock supply control unit 67. Then, the process ends.

By performing the above-described process, the management OS 51 can select a module whose state can be changed from among the modules assigned to the logical partition where the guest OS 52 that has transmitted the operation state change request is executed and determine a state after change. As necessary, the management OS 51 can change the setting of power supply or the clock frequency of the module selected for change of state after saving the context. Accordingly, when change of the operation state is requested from the guest OS 52 because the user does not input any operation for more than a predetermined time period, the management OS 51 can reduce part of the power consumption of the modules without causing an effect on the operations of the other guest OSs 52 that are executed in parallel.

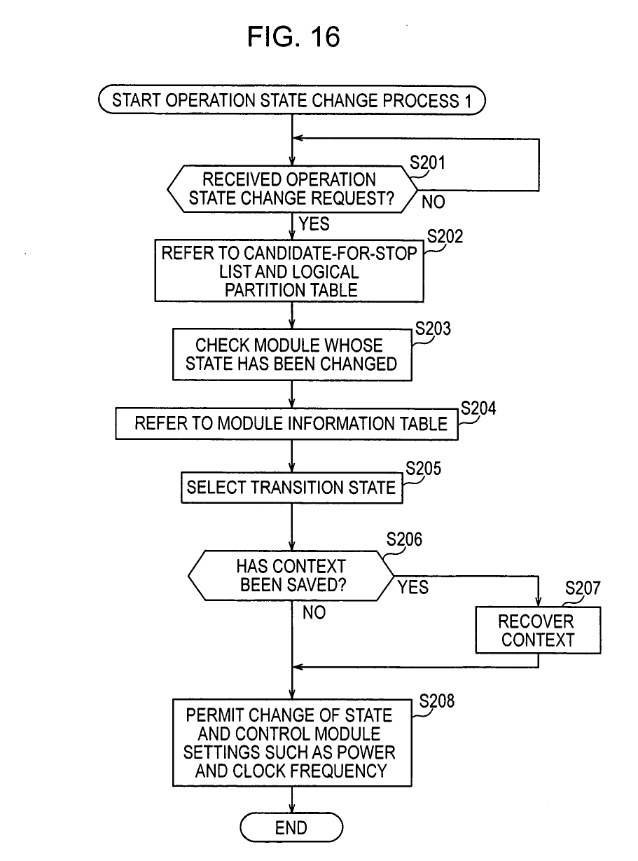

Next, an operation state change process 2 is described with reference to the flowchart shown in FIG. 16. This process is executed by the management OS 51 in order to change the state from a power saving state to a normal state and corresponds to steps S47 to S49 in FIG. 12 or steps S98 to S100 in FIG. 13.

In step S201, the guest OS management control unit 61 determines whether the guest OS management control unit 61 has received an operation state change request from any of the guest OSs 52. When it is determined in step S201 that an operation state change request has not been received, steps S201 is repeated until it is determined that an operation state change request has been received.

When it is determined in step S201 that an operation state change request has been received, the process proceeds to step S202 where the guest OS management control unit 61 refers to the candidate-for-stop list that is generated by the candidate-for-stop list generating unit 63 and that is stored under the control by the candidate-for-stop list storage control unit 64 and the logical partition table that is managed by the logical partition table managing unit 62.

In step S203, the guest OS management control unit 61 checks a module whose state has been changed among the modules assigned to the logical partition where the guest OS 52 that has transmitted the operation state change request is executed based on the candidate-for-stop list and the logical partition table.

In Step S204, the guest OS management control unit 61 refers to the module information table corresponding to the module that can be stopped, the table being managed by the logical partition table managing unit 62.

In step S205, the guest OS management control unit 61 selects a transition state based on the module information table referred in step S204.

In step S206, the guest OS management control unit 61 determines whether the context has been saved in the guest OS 52 whose state is to be changed.

When it is determined in step S206 that the context has been saved, the process proceeds to step S207 where the guest OS management control unit 61 notifies the power controlling context storage control unit 69 that the context needs to be recovered, so that the power controlling context storage control unit 69 recovers the context of the guest OS 52 whose state is to be changed.

When it is determined in step S206 that the context has not been saved, or after step S207, the process proceeds to step S208 where the guest OS management control unit 61 transmits a permission of changing the state to the guest OS 52 that has transmitted the state change request. Also, the guest OS management control unit 61 controls settings of power and a clock frequency of the module in which the state has been changed among the modules assigned to the logical partition where the guest OS 52 that has transmitted the operation state change request is executed, by using the process of the power supply control unit 66 or the clock supply control unit 67. Then, the process ends.

By performing the above-described process, the management OS 51 can recover the module whose state has been changed among the modules assigned to the logical partition where the guest OS 52 that has transmitted the operation state change request is executed.

As described above, the computer system 1 according to an embodiment of the present invention is capable of effectively reducing power consumption in response to a request from the guest OS 52 without causing an effect on the process executed by the other guest OSs 52. Accordingly, the power consumption can be controlled in accordance with the application of each guest OS 52.

The above-described series of processes can be executed by software. In that case, a program constituting the software is installed from a recording medium into a computer incorporated in a dedicated hardware or a general-purpose personal computer that can execute various functions after being installed with various programs.

Examples of this recording medium include the removable medium 24 shown in FIG. 1, which is distributed to provide a program to a user and which contains a program, i.e., a magnetic disk (including a flexible disk), an optical disk (including a compact disk read only memory (CD-ROM) and a digital versatile disk (DVD)), a magneto-optical disk (including a Mini Disk (trade mark) (MD)), or a package medium including a semiconductor memory.

In this specification, the steps describing the program recorded on the recording medium may be executed in time series according to the described order. Alternatively, the steps may be executed in parallel or individually.

In this specification, the “system” means the entire constitution composed of one or a plurality of devices.

It should be understood by those skilled in the art that various modifications, combinations, sub-combinations and alterations may occur depending on design requirements and other factors insofar as they are within the scope of the appended claims or the equivalents thereof.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. An information processing system including a plurality of computing means, the information processing system comprising:
operating system execution means for executing an operating system; and
management application execution means for executing a management application that manages an operation of the operating system,
wherein the operating system execution means and the management application execution means correspond to any of the plurality of computing means,
the operating system execution means can execute a plurality of operating systems,
at least one of the plurality of operating systems that are executed by the operating system execution means has a function of transmitting a state change request to the management application, and
when the management application executed by the management application execution means receives a state change request from a first operating system in a state where the plurality of operating systems are executed by the operating system execution means, the management application controls an operation state of a set of physical resources used by the first operating system.

2. The information processing system according to claim 1,
wherein the management application executed by the management application execution means has a logical partitioning function of logically partitioning the physical resources and allowing respective sets of the physical resources to execute different processes, and
wherein the plurality of operating systems executed by the operating system execution means are respectively executed in a plurality of logical partitions generated by the logical partitioning function of the management application.

3. The information processing system according to claim 1, wherein at least part of the operating system execution means and at least part of the management application execution means correspond to the same set of the physical resources.

4. The information processing system according to claim 1, wherein the management application executed by the management application execution means has a function of controlling power supply to the set of physical resources used by the first operating system when receiving a state change request from the first operating system.

5. The information processing system according to claim 4, further comprising:
recording means for recording predetermined information and being exclusively used by the management application executed by the management application execution means,
wherein the management application executed by the management application execution means has a function of allowing the recording means to record information about an execution state or an executed process of the set of physical resources used by the first operating system and then controlling power supply to the set of physical resources when receiving a state change request from the first operating system.

6. The information processing system according to claim 4, further comprising:
recording means for recording predetermined information and not being exclusively used by the first operating system as a set of the physical resources,
wherein the management application executed by the management application execution means has a function of allowing the recording means to record information about an execution state or an executed process of the set of physical resources and then controlling power supply to the set of physical resources used by the first operating system when receiving a state change request from the first operating system.

7. The information processing system according to claim 1, wherein the management application executed by the management application execution means has a function of controlling a clock frequency supplied to the set of physical resources used by the first operating system.

8. The information processing system according to claim 1, wherein, when the management application executed by the management application execution means receives a state change request from the first operating system in a state where the plurality of operating systems are executed by the operating system execution means, the management application controls an operation state of a set of the physical resources that is used by the first operating system and that is not used by the operating systems other than the first operating system that transmitted the state change request.

9. The information processing system according to claim 8,
wherein the management application executed by the management application execution means has a list generating function of generating a list of sets of the physical resources occupied by any of the operating systems in a state where the plurality of operating systems are executed by the operating system execution means, and
wherein, when the management application receives a state change request from the first operating system in a state where the plurality of operating systems are executed by the operating system execution means, the management application refers to the list generated by the list generating function and controls an operation state of the set of physical resources that is used by the first operating system and that is not used by the operating systems other than the first operating system that transmitted the state change request.

10. The information processing system according to claim 1, wherein, when the management application executed by the management application execution means receives a state change request from the first operating system in a state where the plurality of operating systems are executed by the operating system execution means, the management application controls an operation state of the set of physical resources only during a period assigned to be used by the first operating system in time division.

11. The information processing system according to claim 10,
wherein the management application executed by the management application execution means has a logical partitioning function of logically partitioning the physical resources and allowing respective sets of the physical resources to execute different processes,
wherein the management application has a list generating function of generating a list of the sets of the physical resources used in respective logical partitions that are generated by the logical partitioning function in a state where the plurality of operating systems are executed by the operating system execution means in the respective logical partitions, and
wherein, when the management application receives a state change request from the first operating system in a state where the plurality of operating systems are executed by the operating system execution means, the management application refers to the list generated by the list generating function and controls an operation state of the set of physical resources only during a period assigned to be used by the first operating system in time division.

12. The information processing system according to claim 1,
wherein at least one of the plurality of operating systems executed by the operating system execution means has a function of transmitting a request for changing an operation state of another of the operating systems to the management application executed by the management application execution means, and
wherein, when the management application executed by the management application execution means receives a request for changing an operation state of the first operating system from a second operating system while controlling an operation state of the first operating system, the management application controls the operation state of the first operating system based on the request.

13. An information processing method for processing information by using a plurality of computing means, the information processing method comprising the steps of:
transmitting a state change request from a first operating system executed by any of the plurality of computing means to a management application that manages an operation of the operating system;
extracting a set of physical resources whose state can be controlled without causing an effect on a process of a second operating system that is executed in parallel with the first operating system based on the state change request transmitted in the transmitting step; and
controlling a state of the set of physical resources extracted in the extracting step.

14. A program for allowing a computer to execute a process of information using a plurality of computing means, the process comprising the steps of:
transmitting a state change request from a first operating system executed by any of the plurality of computing means to a management application that manages an operation of the operating system;
extracting a set of physical resources whose state can be controlled without causing an effect on a process of a second operating system that is executed in parallel with the first operating system based on the state change request transmitted in the transmitting step; and
controlling a state of the set of physical resources extracted in the extracting step.

15. An information processing system including a plurality of computing units, the information processing system comprising:
an operating system execution unit executing an operating system; and
a management application execution unit executing a management application that manages an operation of the operating system,
wherein the operating system execution unit and the management application execution unit correspond to any of the plurality of computing units,
the operating system execution unit can execute a plurality of operating systems,
at least one of the plurality of operating systems that are executed by the operating system execution unit has a function of transmitting a state change request to the management application, and
when the management application executed by the management application execution unit receives a state change request from a first operating system in a state where the plurality of operating systems are executed by the operating system execution unit, the management application controls an operation state of a set of physical resources used by the first operating system.
